(19) United States
(12) Patent Application Publication
(10) Pub. No.: US 2011/0161247 A1
(43) Pub. Date: Jun. 30, 2011

(54) SYSTEMS AND METHODS FOR OPTIMIZING TAX

(75) Inventor: David W. Gannalo, Paradise Valley, AZ (US)

(73) Assignee: Networth Services, Inc.

(21) Appl. No.: 12/977,961

(22) Filed: Dec. 23, 2010

Related U.S. Application Data
(60) Provisional application No. 61/289,693, filed on Dec. 23, 2009.

(51) Int. Cl. G06Q 40/00

(52) U.S. Cl. 705/36 T

(57) ABSTRACT

Systems and methods for optimizing a tax consequence of an asset according to various aspects of the present invention may comprise a user interface, a database linked to the user interface, and a display. The user interface may be configured to receive information associated with the asset and a desired outcome. The database may be linked to the user interface and configured to store the information associated with the asset. The asset comprises at least one tax lot, and each tax lot was purchased prior to the occurrence of the taxable event. The display may be configured to present which tax lot achieves the desired outcome based upon the sale information associated with the taxable event.

### CROSS-REFERENCES TO RELATED APPLICATIONS

The present application claims the benefit of U.S. Provisional Patent Application 61/289,693, filed Dec. 23, 2009, entitled “Systems and Methods for Optimizing Tax.”

### BACKGROUND OF THE INVENTION

Selecting an asset, such as a security or group of securities, to be sold from an investment portfolio requires consideration of many variables. One important variable is the determination of the tax consequences from a taxable event based on the sale of an asset. The taxable event occurs when the asset is sold or otherwise disposed of by the owner of the asset. Typically, the tax to be paid on the sale may be for the gain in value of the investment. However, the loss in value of the investment may also have tax advantages, such as reducing tax.

The tax basis of the sale determines the tax consequences. The gain or loss may comprise the difference between the amount of money spent to acquire the asset and the amount of money resulting from the sale. The cost of acquiring the asset may include the price of the asset, sales commissions, and/or adjustments to the tax basis such as undistributed capital gains or a return of capital distributions.

Optimizing the gain or loss to achieve desired financial goals, such as maximizing gain, minimizing loss, minimizing taxes, achieving a desired amount of proceeds from the sale, and the like, may be a complicated and time consuming process. Specifically, optimizing the gain or loss of the sale of the asset may require identifying tax lots whose sale will result in the desired tax advantages. Tax lots may comprise the record of transactions and their tax implications for the asset. The tax lot of a security, such as a stock or mutual fund, may be identified by the purchase date of the security such that the holder of the security may specify which particular shares to sell, resulting in achieving a desired financial goal. The burden of optimizing tax consequences of security sales by identifying advantageous tax lots is time consuming and complicated, requiring many hours of research, calculation, sorting through investment portfolios comprising numerous securities, and presenting the holder of those securities with options for achieving their financial goals. The tax basis is not only an important figure for determining the optimization of tax in security sales, but the tax basis must also be determined under the various provision of the Internal Revenue Code, rulings, and regulations.

### SUMMARY OF INVENTION

Systems and methods for optimizing a tax consequence of an asset according to various aspects of the present invention may comprise a user interface, a database linked to the user interface, and a display. The user interface may be configured to receive information associated with the asset and a desired outcome. The database may be linked to the user interface and configured to store the information associated with the asset. The asset comprises at least one tax lot, and each tax lot was purchased prior to the occurrence of the taxable event. The display may be configured to present which tax lot achieves the desired outcome based upon the sale information associated with the taxable event.

### BRIEF DESCRIPTION OF THE DRAWING FIGURES

A more complete understanding of the present invention may be derived by referring to the detailed description when considered in connection with the following illustrative figures. In the following figures, like reference numbers refer to similar elements and steps throughout the figures.

FIG. 1 is a block diagram representatively illustrating a tax optimization system in accordance with an exemplary embodiment of the present invention;

FIGS. 2A and 2B depict a screen shot of a graphical user interface that may be accessed by a user in accordance with an embodiment of the present invention;

FIGS. 3A and 3B depict a screen shot of a graphical user interface that may be accessed by a user in accordance with an embodiment of the present invention;

FIGS. 4A and 4B depict an output screen in accordance with an embodiment of the present invention; and

FIG. 5 is a flow chart illustrating a method of operation of a representative implementation of the tax optimization system by a user;

FIG. 6 depicts an output screen in accordance with an additional embodiment of the present invention; and

FIGS. 7A-7D depict an additional example of the screen shots of FIGS. 3A and 3B and output screen of FIGS. 4A and 4B.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various process steps, apparatus, systems, methods, etc. In addition, the present invention may be practiced in conjunction with any number of systems and methods for providing a computer-implemented system or method for determining the optimization of tax associated with a taxable event, and the system described is merely one exemplary application for the invention. Further, the present invention may employ any number of conventional techniques for acquiring tax rates, rules, and/or laws, the history of transactions associated with the taxable event such as the sale of a security, identifying tax lots, determining gain and/or loss in the taxable event such as the sale of the security, determining the dates of purchase and/or sales of the security, determining the price of the security, commodity, and/or property at any given time, and the like.

The particular implementations shown and described are illustrative of the invention and its best mode and are not intended to limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Various representative implementations of the present invention may be applied to any system or method for determining the optimization of tax associated with a taxable event. Certain representative implementations may comprise a user interface, such as a website interface or graphical user interface, and/or a database for storing, updating, exchanging, analyzing, processing, communicating, and/or displaying the acquired information relating to the taxable event.

Software and/or software elements according to various aspects of the present invention may be implemented with any appropriate programming or scripting language, such as, C, C++, Java, COBOL, assembler, PERL, eXtensible Markup Language (XML), PHP, etc., or any other suitable programming and/or scripting language.

Various representative algorithms may be implemented with any suitable combination of data structures, objects, processes, routines and/or other programming elements. Further, the present invention may employ any number of conventional techniques for data transmission, signaling, data processing, network control, and/or the like. Applications according to various aspects of the present invention may be formulated and a network may be provided that may include any system for exchanging data, such as the Internet, an intranet, an extranet, WAN, LAN, satellite communications, any suitable wireless Internet connection, and/or the like. The network may be implemented as other types of networks, such as an interactive television (ITV) network. The users may interact with the system by any input device such as a keyboard, mouse, kiosk, personal digital assistant, handheld computer, cellular phone such as a smartphone that may have access to the Internet, text messaging by cellular phone, and/or the like. Similarly, the invention may be used in conjunction with any type of personal computer, network computer, workstation, minicomputer, mainframe, or the like running any operating system such as any version of Windows, Windows XP, Windows Longhorn, Windows Whistler, Windows ME, Windows Mobile, Windows NT, Windows 2000, Windows Server, Windows 98, Windows 95, Windows Vista, Windows 7, MacOS, OS/2, BeOS, Linux, UNIX, or any other operating system, whether now known or hereafter. Moreover, the invention may be implemented with TCP/IP communications, IPX, AppleTalk, IP-6, NetBIOS, OSI or any number of existing or future protocols. Moreover, the system may comprise the use, sale and/or distribution of all goods, services, and/or information having similar functionality described herein.

The system may be connected by a data communication network. The data communication network may be a public network, and may secure or unsecure and open to eavesdroppers. In one exemplary implementation, the data communication network may be embodied as the Internet. In this context, computers may or may not be connected to the Internet at all times.

A variety of conventional communications media and protocol may be used for data links, such as a connection to an Internet Service Provider (ISP) over a local loop as is typically used in connection with standard modem communication, wireless cellular communication, cable modem, satellite television providers, Integrated Service Digital Network (ISDN), Digital Subscriber Line (DSL), and/or various wireless communication methods. Polymorph code systems might also reside within a local area network (LAN) which interfaces to a network through a leased line (T1, T3, etc.).

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable non-transitory computer-readable storage medium may be utilized, including hard disks, CD-ROM, optical storage devices, magnetic storage devices, and/or USB memory keys and the like.

Data communication may be accomplished through any suitable communication system, such as, a telephone network, intranet, Internet, point of interaction device (point of sale device, personal digital assistant, cellular phone, kiosk, etc.), online communications, off-line communications, wireless communications, a radio dispatch network, and/or the like. Further, for security reasons, any databases, systems, and/or components of the present invention may comprise any combination of databases or components at a single location or at multiple locations, wherein each database or system includes any of various suitable security features, such as firewalls, access codes, encryption, de-encryption, compression, decompression, and/or the like.

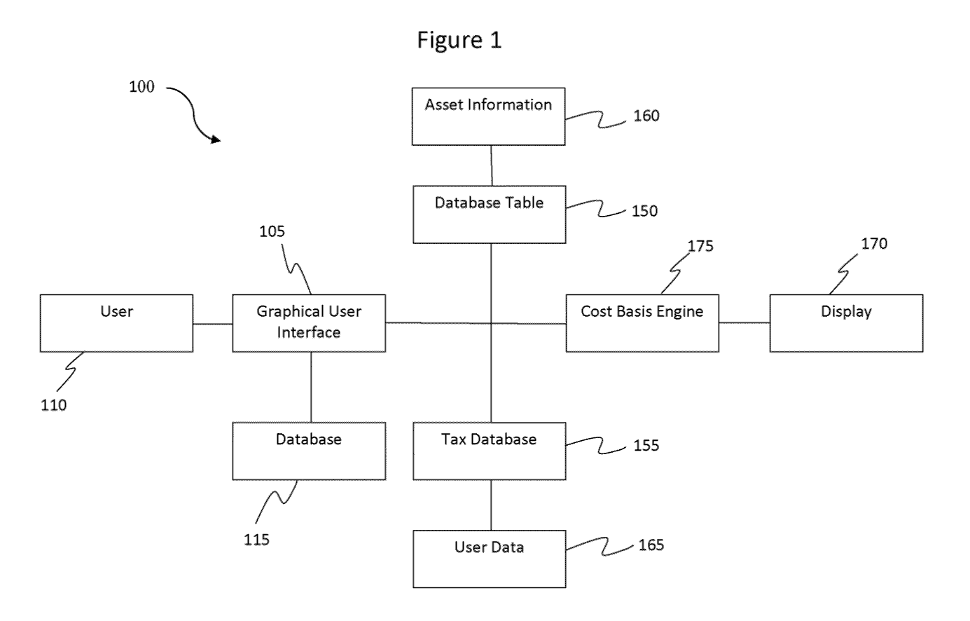

Referring now to FIG. 1, systems and methods for optimizing tax in taxable events according to various aspects of the present invention may be representatively illustrated by a tax system 100 for access by a user 110. The tax system 100 may comprise a graphical user interface 105, such as a website interface, for access by the user 110.

The user 110 may comprise an individual, such as the owner of the asset that may be subject to a taxable event. The user 110 may also comprise any suitable person, company, institution and the like that may buy, sell, trade, value, and/or provide tax advice regarding a taxable event. For example, the user 110 may comprise an investment broker and/or dealer, a mutual fund company, a tax professional, a government department such as the IRS, and/or a non-profit institution such as a university or charity and the like.

In one embodiment, according to various aspects of the present invention, the user 110 may own, transact business, evaluate and/or otherwise interact with the assets such as securities, commodities, property such as jewelry, art, and/or real estate, intellectual property, goodwill, and equity ownership interests. The user 110 may access the graphical user interface 105, such as through a personal computer or an online website, to determine the tax basis for a taxable event relating to the sale of the asset. In one embodiment, the asset may comprise a security, such as a stock or bond. The user 110 may use the tax system 100 to optimize the tax for the sale of one or more shares of a security from their investment portfolio. The user 110 may select any number of different securities, such as shares of stock in different companies.

The graphical user interface 105 may comprise any suitable system for communicating, accessing, updating, exchanging information, organizing information, and/or managing information such as by data collection, encryption, acquisition, storage, dissemination, and the like. In one embodiment, the graphical user interface 105 may comprise a website interface, such as an interface for a web server. For example, the web server may comprise a Microsoft® Windows® Internet Information Services (IIS) Web Server.

The tax system 100 may also comprise a database 115 that stores information entered by the user 110, such as to save the information for the user 110 to access at a later date. The database 115 may also comprise other stored information, such as information further discussed below.

In one embodiment, according to various aspects of the present invention, the database 115 of the user 110 and accessible via the graphical user interface 105 may store tax laws and/or regulations, such as the rate of taxation of the asset. The tax laws and/or regulations stored in the database 115 may be updated when the tax laws and/or regulations change. For example, the database 115 may periodically access an IRS tax database 155 to determine whether the tax law and/or regulations have changed and/or may update the tax laws and/or regulations in the database 115 according to the changes. In another embodiment, the graphical user interface 105 may access the IRS tax database 155 to obtain the current tax laws and/or regulations to be applied to the sale of the asset, without maintaining the information in the database 115.

In one embodiment, according to various aspects of the present invention, the graphical user interface 105 may access any suitable repository containing information about the asset. The repository may be any electronic repository that may be accessible, such as through the Internet. For example, the graphical user interface 105 may access a security database table 150 that may store historical price information for the security, such as a stock, bond, mutual fund and/or the like. In one embodiment, the security database table 150 may store a high price, low price, and/or an open price for the security on any day. The security database table 150 may also comprise data for securities having a single price per day, such as mutual funds having a Net Asset Value at close of trading.

The security database table 150 may also store information identifying capital events that have occurred over a given period of time in connection with the various securities. Such capital events may comprise, for example, spin-offs, mergers, stock splits, rights offerings, right redemptions, special dividends, return capital, original issue discounts and dividend reinvestments. The security database table 150 may comprise the capital events for the plurality of different securities. For each capital event stored in the security database table 150, the database may comprise fields corresponding to a name of a company associated with such capital event, a stock symbol associated with such capital event, a date of such capital event, a type (e.g., dividend reinvestment, stock split, spin-off, etc.) of such capital event, a shares held adjustment ratio associated with such capital event, and any other information desired to be associated with the capital event. Any suitable database structure may be used to store information.

In one embodiment, the user 110 may enter user data 165 into the tax system 100 through the graphical interface 105 to provide the tax system 100 information for optimizing the tax in a taxable event, such as the sale of securities. The user data 165 may comprise any suitable information that may allow the tax system 100 to determine which assets entered by the user 110 to sell to achieve the desired financial goal. For example, the user data 165 may comprise the identity and/or quantity of the assets, such as stocks and/or bonds, owned by the user 110 and/or the purchase dates of the assets and the like. The user data 165 may also comprise information compiled and/or analyzed by the user 110, such as the information provided by a broker. For example, the broker may produce the user data 165 from analyzing the stocks owned by the individual 120 to determine the tax lots. The broker may then enter the user data 165 comprising the tax lots into the tax system 100 via the graphical user interface 105.

In one embodiment, the user 110 may enter asset information 160 into the graphical user interface 105 such that the tax system 100 may determine the optimized tax basis utilizing the asset information 160. The user 110 may enter asset information 160 such as the asset type, tax rate, date of asset acquisition, desired gain or loss in the sale of the asset and the like to determine the tax basis of the selling the asset.

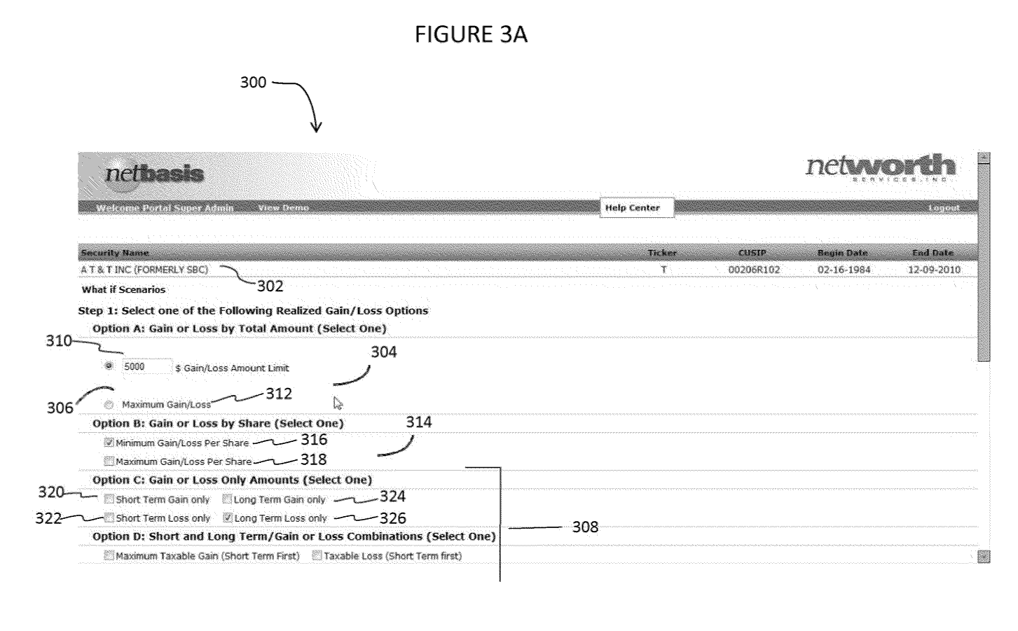

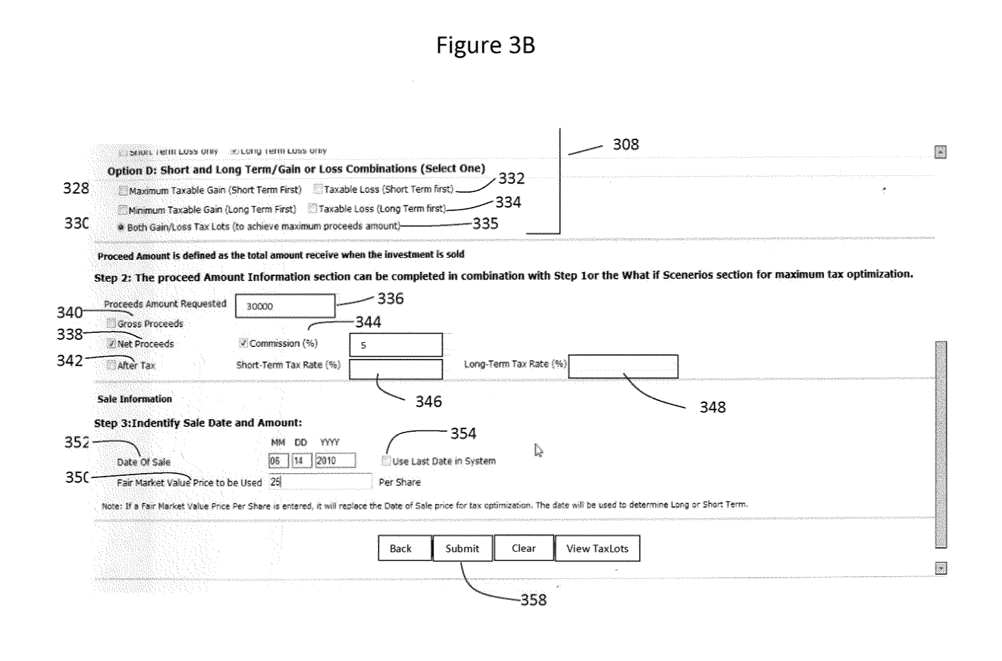

In one embodiment, the user 110 may desire to sell one or more assets, such as a security that may comprise shares of stock according to the desired financial outcome. The user 110 may provide information that may allow the tax system 100 to optimize the tax on the sale of the security. For example, and as discussed below, the user 110 may provide the graphical user interface 105 with the asset information 160 comprising desired financial goals such as net proceeds, gross proceeds, proceeds after the payment of commissions and/or taxes, short-term gain or loss, and/or long-term gain or loss and the like. In one embodiment, the tax system 100 may determine the tax lots of the security to be sold to achieve the financial goals input by the user 110. The tax lot may comprise any transaction involving the security and may include information such as the tax implications associated with the transaction and/or the taxable purchase date of the security and the like. The inputting of the asset information 160 into tax system 100 via the graphical user interface 105 is further discussed below with respect to FIGS. 3A and 3B.

In one embodiment, the tax system 100 may comprise a cost basis engine 175. The cost basis engine 175 may utilize the asset information 160 and the user data 165 to create the tax lots that are displayed to the user 110. An exemplary tax basis engine 175 is disclosed in U.S. Pat. No. 7,606,753 and U.S. Patent Publication Number 2010/0017343, the contents of which are herein incorporated by reference.

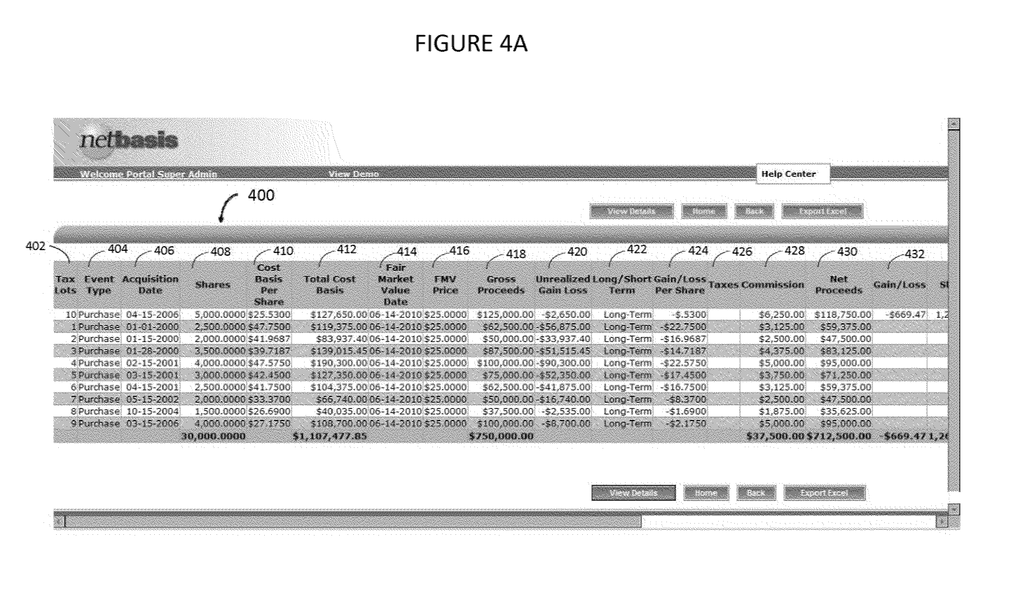

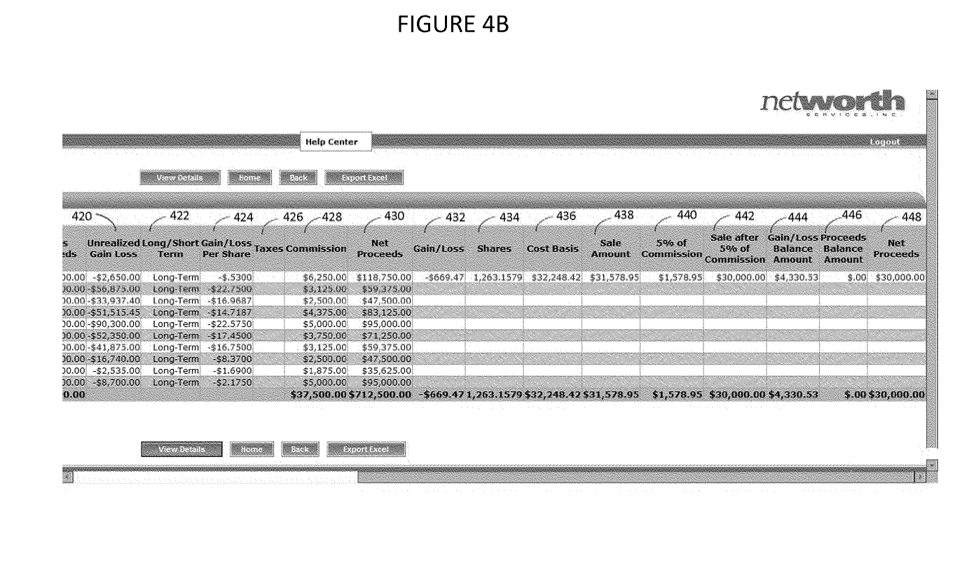

In one embodiment, according to various aspects of the present invention, the tax system 100 may display the asset to be sold to achieve the financial goals input by the user 110 on a display 170. In one embodiment, as discussed in further detail below with regard to FIGS. 4A and 4B, the display 170 may indicate the name of the asset, such as a company name for stock, the tax lot, and shares of the stock to be sold, the date acquired, long or short term gain or loss and the final calculated amount limit, and/or the proceeds amount and the like.

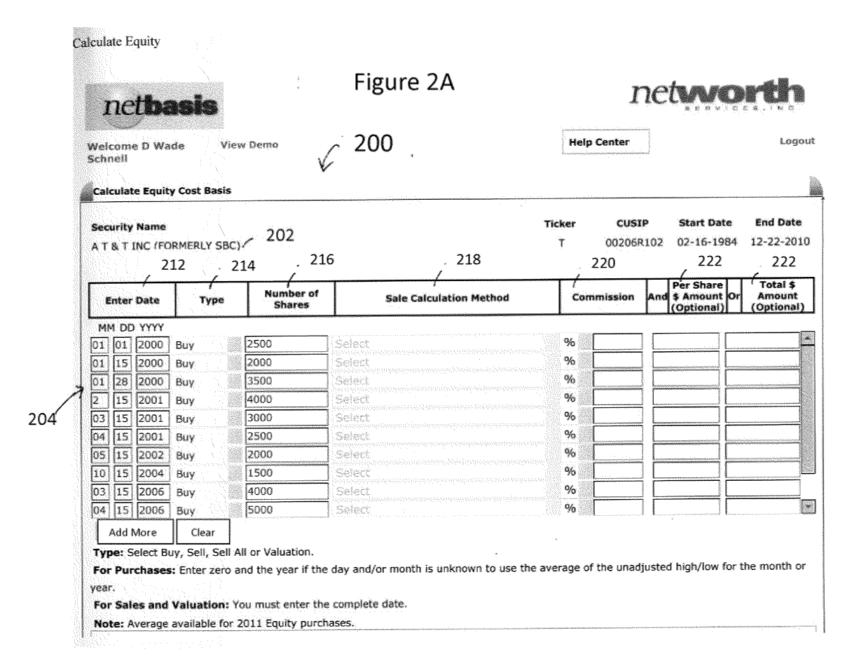

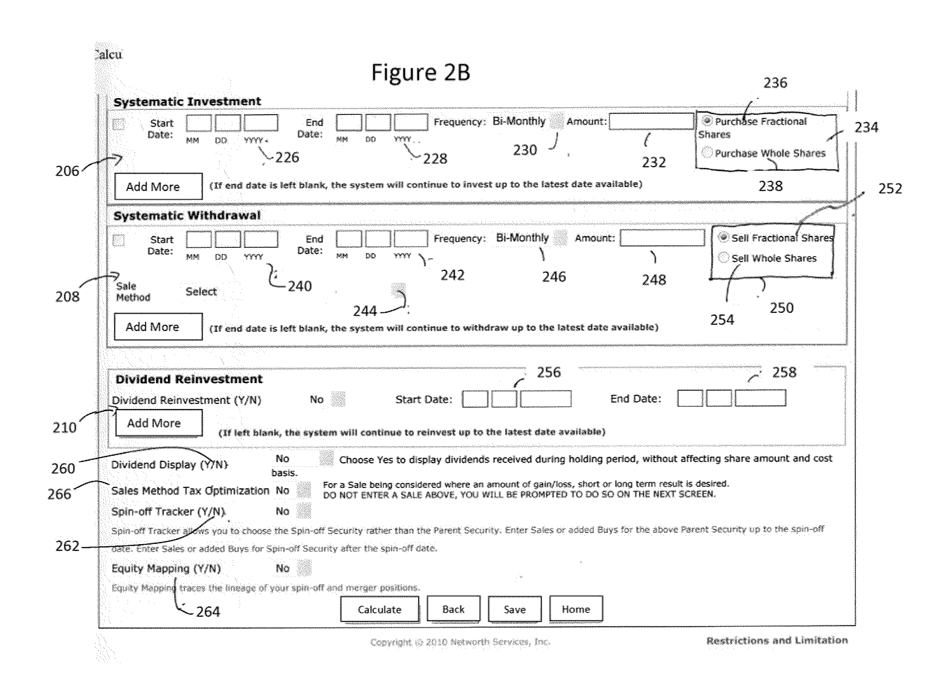

In one embodiment, a mechanism where the user 110 may identify the name of the asset in a data entry module 200 to determine the tax basis for the sale of the asset is shown in FIGS. 2A and 2B. For example, the user 110 may identify the asset, in this case a security 202, such as by a company name, company symbol, and/or a CUSIP number, and enter it into the graphical interface 105. In one embodiment, the database 115 may store a directory of company names, symbols, and/or CUSIP numbers for the user 110 to select.

Once the user 110 has identified the asset or security 202, the user 110 may enter user data 165 in the data entry module 200 to further identify various options for the tax system 100 to use. The data entry module 200 may comprise an asset entry portion 204, an investment entry portion 206, a withdrawal portion 208, and a dividend reinvestment portion 210.

In one embodiment, the asset entry portion 204 may comprise an entry date 212, a disposal type 214, a number of shares 216, and a calculation method 218. Optionally, the asset entry portion 204 may comprise a commission amount 220 and a per share amount 222 or a total amount 224. The disposal type 214 may comprise a drop down menu with multiple options such as a buy option, a sell option, a sell-all option, and a valuation option. The commission amount 220 may be input by a percentage amount or a dollar amount.

The calculation method 218 may also comprise a drop down menu with multiple options. In one embodiment, the calculation method 218 may comprise a first in first out (FIFO) option, where the first tax lots purchased by date would be sold first. In another embodiment the calculation method 218 may comprise a last in first out (LIFO) option, where the last tax lots purchased by date would be chosen. In another embodiment, the calculation method 218 may comprise a specific option, where the user 110 can specifically choose the tax lots and/or sort the tax lots as desired. In another embodiment, the calculation method 218 may comprise an average single option, where the short-term and long-term tax lots are combined. In another embodiment, the calculation method 218 may comprise an average double option, where short term tax lots are averaged and long-term tax lots are averaged and presented separately. In another embodiment, the calculation method 218 may be a highest first out (HIFO) option, where the highest cost basis tax lots are sold first. In another embodiment, the calculation method 218 may comprise a lowest first out (LOFO) option, where the lowest cost basis tax lots are sold first. In another embodiment, the calculation method 218 may comprise an all option where each of the above options is chosen.

The investment entry portion 206 is a mechanism that may be activated by the user selecting the “check” box on the data entry module 200. The investment entry portion 206 may comprise a start date 226, an end date 228, a frequency 230, an amount 232, and share type 234. The frequency 230 may comprise a drop-down menu with the options such as bi-monthly and monthly. The share type 234 may comprise fractional shares 236 or whole shares 238. The investment entry portion 206 allows the user 110 to invest the amount from the start date 226 to the end date 228. If the end date 228 is not specified, the system 100 continues to invest the amount 232 until the latest date available.

The withdrawal portion 208 is a mechanism that may be activated by the user 110 selecting the “check” box on the data entry module 200. The withdrawal portion 208 may comprise a start date 240, an end date 242, a sale method 244, a frequency 246, an amount 248, and share type 250. The frequency 246 may comprise a drop-down menu with the options, such as bi-monthly and monthly. The share type 250 may comprise fractional shares 252 or whole shares 254. The withdrawal portion 208 allows the user 110 to withdraw the amount 248 from the start date 240 to the end date 242 by selling shares of an asset. If the end date 242 is not specified, the system 100 continues to withdraw the amount 248 until the latest date available.

The dividend reinvestment portion 210 is a mechanism that may be selected by the user by choosing “yes” or “no” on the data entry module 200. The dividend reinvestment portion 210 may comprise a start date 256 and an end date 258. If the end date 258 is not specified, the system 100 continues to reinvest the amount until the latest date available.

In one embodiment, the user may also select the options comprising a dividend display 260, a spinoff track 262, and an equity mapping 264 by choosing “yes” or “no” on the data entry module 200. The dividend display 260 option allows the dividends received during the holding period to be displayed, without affecting the share amount and cost basis. The spinoff track option 262 allows the user 110 to choose the spin-off security rather than the parent security. The equity mapping 264 option traces the lineage of the spin-off and merger positions.

In an additional embodiment, a user may select an optimize tax 266 option by choosing “yes” or “no” on the data entry module 200. By choosing the optimize tax 266 option, the tax system 100 directs the user 110 to an asset entry module 300, where additional options for optimizing the tax lots will be present.

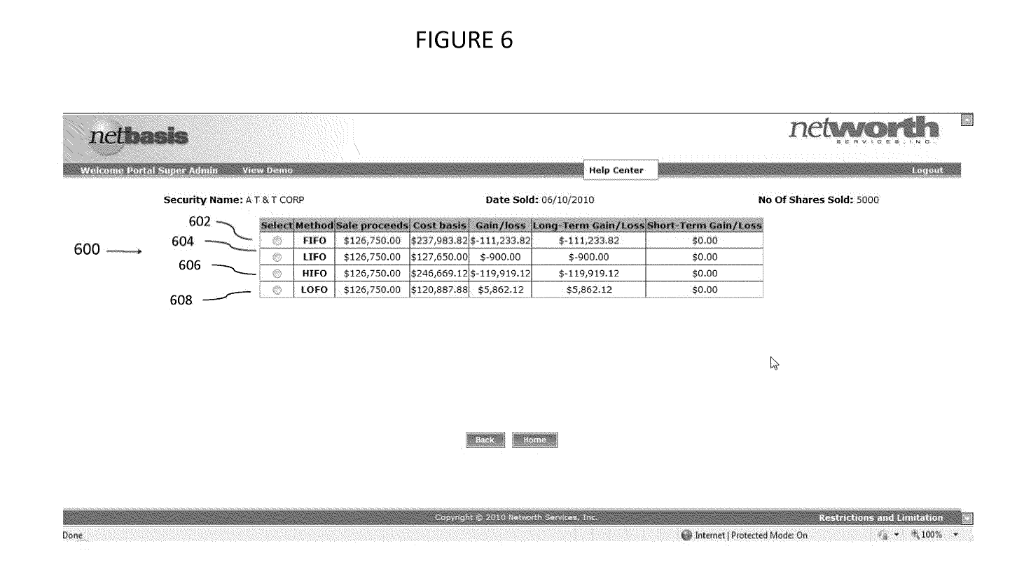

In an alternative embodiment, the user 110 may select to not optimize the tax. In this option, the user 110 would select the all option in the calculation method 218 discussed above. An example of the output 600 for the not optimize tax option is shown in FIG. 6. By choosing to not optimize tax along with the all option as the calculation, the tax system simply may show, for example, the first in first out (FIFO) option 602, the last in first out (LIFO) option 604, the highest first out (HIFO) option 606, and the lowest first out (LOFO) option 608.

Referring now to FIGS. 3A and 3B, in one embodiment, the asset entry module 300 provides the user 110 a mechanism for further identifying options for the tax system 100 to use when optimizing the tax for a disposition of the asset. The asset entry module 300 includes the asset or security 202 from FIG. 2A, now designated by reference numeral 302.

In another embodiment, the user 110 may determine a desired outcome 304 associated with the asset to be calculated by the tax system 100. The desired outcome 304 allows the user 110 to identify the objective of the sale of the asset 302, for example by entering the asset information 160. In one embodiment, the desired outcome 304 may comprise an amount 306 and a disposal type 308. The amount may comprise an amount limit 310 or a maximum amount 312 to be calculated by the system 100. The amount limit 310 may comprise an amount that is input by the user to indicate the dollar amount of gain or loss that the user 110 desires from the disposition of the asset 302. As such, a user may select the amount limit 310 option and input the amount limit 310 of the gain or loss. The user may then select a per share amount 314. The per share amount 314 may comprise a minimum per share amount 316 or a maximum per share amount 318. The per share amount 314 is the amount per share that the user is willing to dispose of the asset 302.

As stated above, the user 110 may also select the maximum amount 312 where the tax system 100 calculates the maximum amount 312 of gain or loss possible.

In one embodiment, the disposal type 308 may comprise one of short-term gain 320, short-term loss 322, long-term gain 324, long-term loss 326, or combinations thereof. For example, in one embodiment, the user 110 may select short-term gain 320 or short-term loss 322 where the short-term gain or loss 320, 322 may be calculated using tax lots held for one year or less and whose sale would create the amount of gain or loss specified in the amount 306.

Further, in one embodiment, the user 110 may select long-term gain 324 or long-term loss 326, where the long-term gain or loss 324, 326 may be calculated using tax lots held for more than one year and whose sale would create the amount of gain or loss specified in the amount 306.

In one embodiment, the disposal type 308 may comprise a combination of gains and losses. For example, the user 110 may select the both short term gain and long term gain 320, 324 with short-term gain calculated first 328. In another embodiment, the user 110 may select both short term gain and long term gain 320, 324 with long-term gain calculated first 330. In another embodiment, the user 110 may select short term loss and long term loss 322, 326, with short-term loss calculated first 332. In another embodiment, the user 110 may select short term loss and long term loss 322, 326, with long-term loss calculated first 334. In another embodiment the user 110 may select both gain and loss tax lots 335, which will achieve the maximum proceeds amount.

In one embodiment, the desired outcome 304 may comprise a proceeds amount 336. Specifically, the user 110 may request that the tax system 100, through the graphical user interface 105, produce the proceeds amount 336 as well as the amount 306. The proceeds amount 336 may be input by the user 110. The proceeds amount 336 may comprise net proceeds 338, gross proceeds 340, after tax 342, and percentage of sales commission 344 options. Accordingly, when selecting the desired outcome the user has the ability to tailor his choice according to the above options.

In one embodiment, the proceeds amount 336 may be dependent on the amount limit 306 of gain or loss indicated by the user 110. In an exemplary embodiment, where both the proceeds amount 336 and the amount limit 306 are specified, and the user 110 indicates a short-term gain 320, long-term gain 324, short-term loss 322, or long-term loss 326, then the tax system 100 may determine the upper limit on both the proceeds amount 336 and the amount limit 306, with the lower limit controlling the other result.

For example, if the user 110 enters $15,000 as the proceeds amount 336, and $3,000 as the amount limit 306, and selects long-term gain, then selling tax lots to create a $3,000 long-term gain may yield only $12,000 as the proceeds amount 336 (i.e., $15,000-$3,000). Further, the sale of tax lots may yield $15,000 as the proceeds amount 336, but only a $2,000 long-term gain.

In one embodiment, the user 110 may specify a type of proceeds amount 336. For example, the user 110 may specify that the proceeds amount 336 comprise the net proceeds 338 or the gross proceeds 340. In another embodiment, the user 110 may specify that the proceeds amount 336 take into account certain information, such as a sales commission 344 from a broker 125 that may transact the sale of the security. The user 110 may also indicate the percentage of the commission 344 to be paid. In another embodiment, the user 110 may select that the proceeds amount 336 reflect an amount after taxes 342 are paid. If the user 110 chooses that the proceeds amount reflect the amount after taxes, the user may select a short-term tax rate 346 or a long-term tax rate 348, and then enter the amount in the area provided.

In one embodiment, the tax system 100 may comprise a sell portion 350. The sell portion 350 may comprise an actual sale date 352, a last date 354, or fair market value 356. In one embodiment, the user may select the actual sale date 352, which allows the user 110 to enter a date of sale of the asset, such as a security to determine the optimized tax basis. In an alternative embodiment, the user 110 may choose for the tax system 100 to use the last date 354 in the system 100 as the date of sale. The date of sale of the asset may impact the value of the asset and therefore the resulting tax basis. In another alternative embodiment, instead of entering the actual sale 352 or the last date 354, the user 110 may enter a dollar amount as the fair market value price 356 to be used in determining the optimized tax basis.

In one embodiment, once the user 110 has entered the asset information 160 in the asset entry module 300, the user 110 may select a submit option 358 on the asset entry module 300. By choosing the submit option 358, the tax system 100 utilizes the cost basis engine 175 to determine the tax lots and directs the user 110 to an output module 400, where a summary of the tax lots may be presented.

Referring now to FIGS. 4A and 4B, in one embodiment, the tax lot output 400 may comprise a tax lot 402, an event type 404, an acquisition date 406, shares held in tax lot 408, a cost basis per share 410, a total cost basis 412, a fair market value date 414, a fair market value price 416, gross proceeds 418, unrealized gain/loss 420, long/short term 422, gain/loss per share 424, tax amounts 426, sale commission 428, net proceeds 430, gain/loss 432, number of shares 434 (216), cost basis 436, sale amount 438, percent of commission 440, sale after percent of commission 442, gain/loss balance amount 444, proceeds balance amount 446, and net proceeds 448.

The tax lot 402 may comprise a serial number of the lot. The serial number of the lot is typically in order of the date that the asset was entered by the user 110. The event type 404 may comprise the method of acquiring the tax lot, where the method may comprise a purchase, a dividend, or a corporate action. The acquisition date 406 may comprise the date the tax lot was acquired, based upon tax dating. If the asset was required by spin-off, the spin-off has the original date of the acquisition and not the date of spin off. The share amount 408 may comprise the number of shares held in that tax lot.

The cost basis per share 410 may comprise the price per share held in the tax lot. The cost basis per share 410 is calculated by dividing cost basis by shares in the tax lot. The fair market value date 414 may comprise the date when the fair market value was determined and the fair market value price 416 may comprise the average of the high or low price on date indicated and or sale price entered.

The gross proceeds 418 may comprise an amount calculated by multiplying the shares by fair market value. The unrealized gain or loss 420 may comprise the gain or loss that is calculated by subtracting total cost basis from gross proceeds. The long/short term 422 may comprise a classification for tax reporting. Twelve (12) months and one day is classified as long term while twelve (12) months or less is classified as short term. The gain/loss per share 424 may comprise the gain or loss per share that is calculated by dividing the unrealized gain or loss by the shares in the tax lot.

The tax amounts 426 may comprise the amount of taxes that are attributed to the sale of the tax lot calculated at a rate entered in asset entry module 300 at short term tax rate 346 or long term tax rate 348. The sale commission 428 may comprise the commission attributed to the sale of that lot calculated at a rate entered in asset entry module 300 at 344.

The net proceeds 430 may comprise the amount of proceeds that are calculated by subtracting the commissions and or taxes from gross proceeds. The gain/loss 432 may comprise the tax lot gain or loss based upon tax lot chosen to be sold. The shares 434 may comprise the shares 216 in the tax lot to be sold based upon criteria entered in the data entry module 200.

The cost basis 436 may comprise the cost basis of shares from tax lot to be sold. The sale amount 438 may comprise the amount attributed to tax lot based upon shares sold. The percent of commission 440 may comprise the calculated commission based upon the inputs on the displayed tax lot. The sale after percent of commission 442 may comprise the calculated sale amount less the percent of commission 440. The gain/loss balance amount 444, proceeds balance amount 446, and net proceeds 448 are conventional terms and figures.

For example, referring again to FIGS. 3A, 3B, 4A and 4B, the user has entered $5,000 as the amount limit 310, selected the minimum share amount 316, selected long term loss 326, selected both gain and loss tax lots 335, selected the proceeds amount 336 of $30,000, selected net proceeds 338, selected a five percent (5%) commission 344, selected the actual sale date 352 of Jun. 14, 2010, and selected the fair market value price 356 of twenty-five dollars per share ($25/share). After selecting submit 358, the tax lot output 400 is shown in FIGS. 4A and 4B. The tax lot output 400 shows the acquisition date 406 of the shares and the shares held in the tax lot 5,000 sold at the fair market value date 414 of Jun. 14, 2010 as selected in as the actual sale date 352. The shares were sold at a fair market value price 416 of twenty-five dollars per share ($25/share) as selected in as fair market value price 356. The net proceeds 448 are $30,000 as selected as the proceeds amount 336.

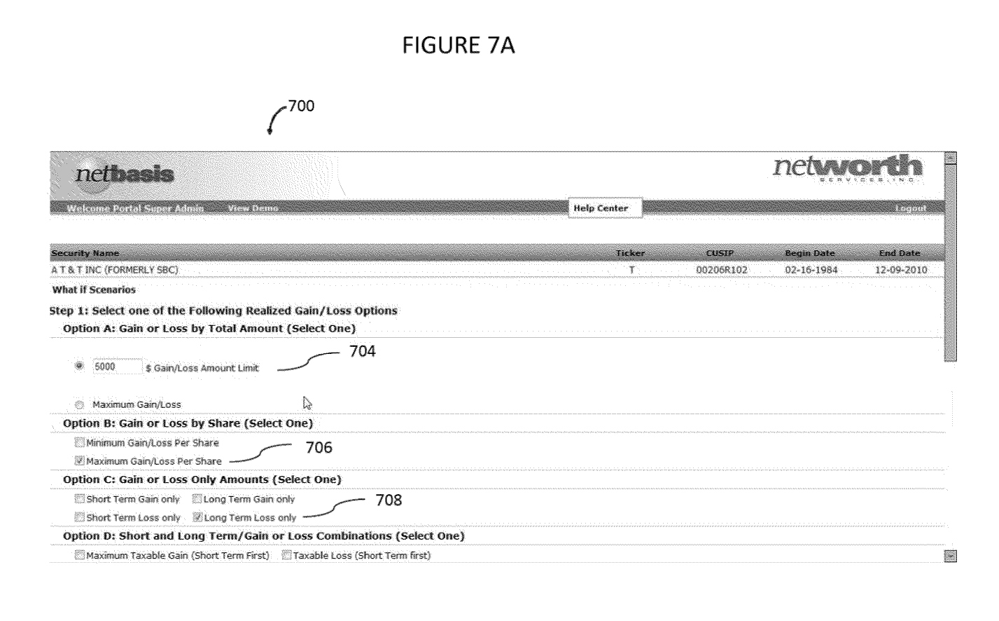

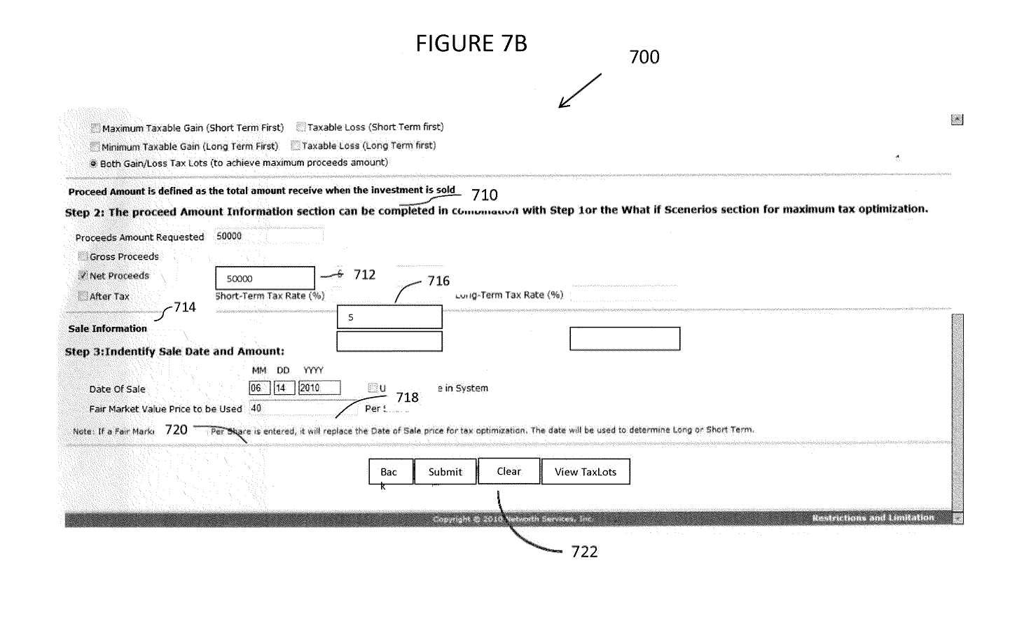

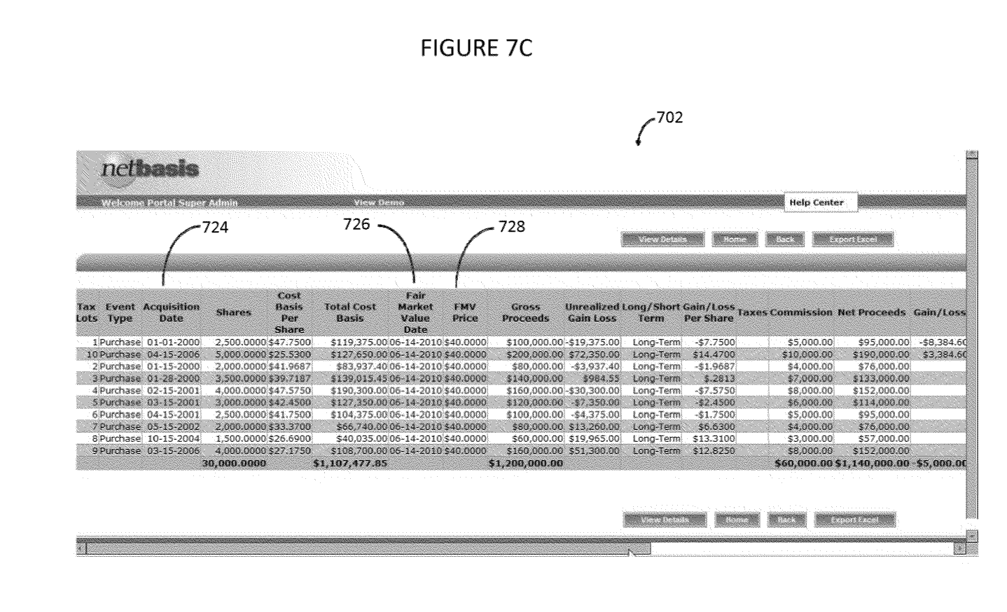

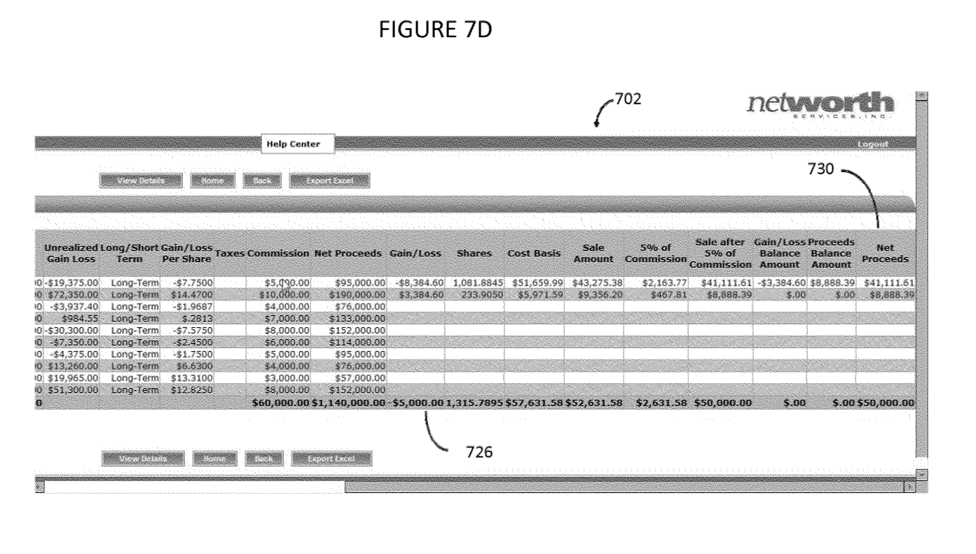

Referring now to FIGS. 7A-7D, an asset entry module 700 similar to FIGS. 3A and 3B shows a tax lot output 702 similar to that shown in FIGS. 4A and 4B above. The user has entered $5,000 as an amount limit 704, selected a maximum per share amount 706, selected long term loss 708, selected both gain and loss tax lots 710, selected the proceeds amount 712 of $50,000, selected net proceeds 714, selected a five percent (5%) commission 716, selected the actual sale date 718 of Jun. 14, 2010, and selected the fair market value price 720 of forty dollars per share ($40/share). After selecting submit 722 the tax lot output 702 is shown in FIGS. 7C and 7D. The tax lot output 702 shows the acquisition date 724 of the shares and the shares held in the tax lot 2,500 sold at the fair market value date 726 of Jun. 14, 2010 as selected in as the actual sale date 718. The shares were sold at a fair market value price 728 of forty dollars per share ($40/share) as selected in as fair market value price 720. The net proceeds 730 are $50,000 as selected as the proceeds amount 712. The shares also generated a maximum loss 732 of $5000 as selected in amount limit 704.

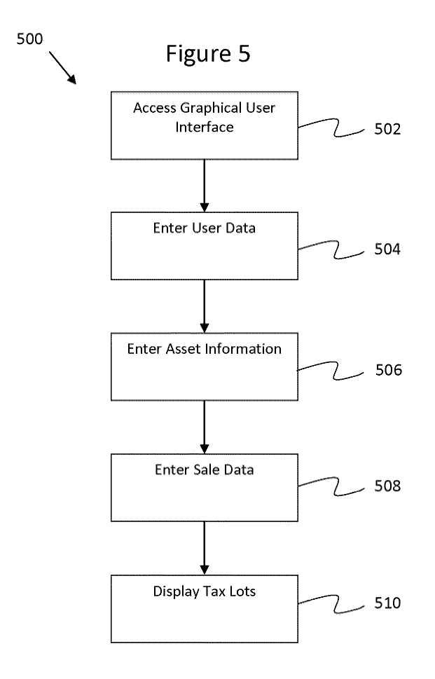

Referring to FIG. 5, a method of operation (500) according to various aspects of the present invention may comprise accessing the graphical user interface 105 by the user 110 (502). The user 110 may enter user data 165 in the data entry module 200 via the graphical user interface 105, such as the tax lots, the identity of an asset such as a security, and/or the date of purchase of the asset and the like (504). For example, utilizing the data entry module 200, the user 110 may enter any one of the entry date 212, the disposal type 214 and the number of shares 216. Optionally, the user 110 may enter the sales calculation method 218, the commission amount 220, and the per share amount 222 for the total amount 224.

The user 110 may also enter asset information 160 comprising the desired outcome 304 into the asset entry module 300 via the graphical user interface 105 (506). The desired outcome may comprise the amount 304 and the disposal type 306. The amount may comprise the gain or loss desired from the sale of the asset. In one embodiment, the user 110 may select the maximum short-term or long-term gain or loss possible. Optionally, the user 110 may select criteria for choosing the tax lots to be sold, such as selecting short-term loss or gain, long-term loss or gain, or both short-term gain or loss and long-term gain or loss. The user 110 may also select for the tax system 100 to choose tax lots having the minimum or maximum gain or loss on a per share basis

Optionally, the desired outcome may comprise the proceeds amount 336 and the sale portion 350. The proceeds amount 336 may comprise any amount the user 110 desires to result from the sale or the asset and may be used by the user 110 for any purpose. Where the user 110 chooses a specific proceed amount 336, the user may designate that the proceed amount 336 comprise net proceeds 338 or gross proceeds 340. In one embodiment, the user 110 may select for the proceed amount 336 to comprise an amount calculated after the payment of taxes 342 and/or commissions 344.

In one embodiment, the user 110 may also provide sale data 350 for the asset, such as by directing the tax system 100 to use the fair market value 356, date of sale of the asset 352, or the last date in the database 354 (508).

In one embodiment, the user 110 may view the tax lots determined by the tax system 100 to be sold to achieve the financial goals dictated by the information input into the tax system 100, such as through a display appearing on the graphical user interface 105 (510).

The invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential features or components.

The terms “comprises”, “comprising”, or any variation thereof, are intended to reference a non-exclusive inclusion, such that a process, method, article, composition, system, or apparatus that comprises a list of elements does not include only those elements recited, but may also include other elements not expressly listed or inherent to such process, method, article, composition, system, or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

The present invention has been described above with reference to an exemplary embodiment. However, changes and modifications may be made to the exemplary embodiment without departing from the scope of the present invention. These and other changes or modifications are intended to be included within the scope of the present invention.

1. A system for optimizing a tax consequence of an asset following an occurrence of a taxable event, comprising:
a user interface configured to receive information associated with the asset and a desired outcome;
a database linked to the user interface and configured to store the information associated with the asset, wherein the asset comprises more than one tax lot, and each tax lot was purchased prior to the occurrence of the taxable event; and
a display configured to present which tax lot achieves the desired outcome based upon the sale information associated with the taxable event.

2. A system for optimizing a tax consequence of an asset following an occurrence of a taxable event according to claim 1, wherein the information associated with the asset comprises a date, a disposal type, and a number of shares.

3. A system for optimizing a tax consequence of an asset following an occurrence of a taxable event according to claim 2, wherein the information associated with the asset further comprises a calculation method.

4. A system for optimizing a tax consequence of an asset following an occurrence of a taxable event according to claim 1, wherein the desired outcome comprises an amount.

5. A system for optimizing a tax consequence of an asset following an occurrence of a taxable event according to claim 1, wherein the desired outcome further comprises a proceeds amount.

6. A system for optimizing a tax consequence of an asset following an occurrence of a taxable event according to claim 5, wherein the proceeds amount may comprise one or more of net proceeds, gross proceeds, after tax proceeds or after commission proceeds.

7. A system for optimizing a tax consequence of an asset following an occurrence of a taxable event according to claim 1, wherein the desired outcome further comprises a disposal type.

8. A system for optimizing a tax consequence of an asset following an occurrence of a taxable event according to claim 6, wherein the disposal type comprises at least one of a short-term gain, a short-term loss, a long-term gain, and a long-term loss.

9. A system for optimizing a tax consequence of an asset following an occurrence of a taxable event according to claim 1, wherein the desired outcome further comprises a sale date.

10. A computer-implemented method for optimizing a tax consequence of an asset following an occurrence of a taxable event, comprising:
inputting information associated with the asset;
inputting a desired outcome;
retrieving an asset from a database, wherein the asset comprises more than one tax lot, and wherein each tax lot was purchased prior to the occurrence of the taxable event;
comparing the tax lot with the desired outcome;
determining which tax lot associated with the asset achieves the desired outcome based upon sale information associated with the taxable event;
displaying the tax lot to the user.

11. A computer-implemented method for optimizing a tax consequence of an asset following an occurrence of a taxable event according to claim 10, wherein the desired outcome further comprises an amount.

12. A computer-implemented method for optimizing a tax consequence of an asset following an occurrence of a taxable event according to claim 11, wherein the desired outcome further comprises a proceeds amount.

13. A computer-implemented method for optimizing a tax consequence of an asset following an occurrence of a taxable event according to claim 12, wherein the proceeds amount may comprise one or more of net proceeds, gross proceeds, after tax proceeds or after commission proceeds.

14. A computer-implemented method for optimizing a tax consequence of an asset following an occurrence of a taxable event according to claim 10, wherein the information associated with the asset comprises a date, a disposal type, and a number of shares.

15. A computer-implemented method for optimizing a tax consequence of an asset following an occurrence of a taxable event according to claim 14, wherein the information associated with the asset further comprises a calculation method.

16. A computer-implemented method for optimizing a tax consequence of an asset following an occurrence of a taxable event according to claim 10, wherein the desired outcome further comprises a disposal type.

17. A computer-implemented method for optimizing a tax consequence of an asset following an occurrence of a taxable event according to claim 16, wherein the disposal type comprises at least one of a short-term gain, a short-term loss, a long-term gain, and a long-term loss.

18. A computer-implemented method for optimizing a tax consequence of an asset following an occurrence of a taxable event according to claim 10, wherein the desired outcome further comprises a sale date.
